(19) United States
(12) Patent Application Publication
(10) Pub. No.: US 2015/0355762 A1
(43) Pub. Date: Dec. 10, 2015

(54) MID-FRAME BLANKING

(71) Applicant: Apple Inc., Cupertino, CA (US)

(72) Inventors: Brijesh Tripathi, Los Altos, CA (US); Manu Agarwal, Palo Alto, CA (US); Peter F. Holland, Los Altos, CA (US)

(21) Appl. No.: 14/296,105

(22) Filed: Jun. 4, 2014

(51) Int. Cl. G06F 3/041; H04N 3/24; G06T 1/20

(52) U.S. Cl. CPC G06F 3/0412; G06T 1/20; H04N 3/24; G06F 2203/04101; H04N 2101/00

(57) ABSTRACT

Systems, apparatuses, and methods for performing mid-frame blanking. A first portion of a frame is driven to a display and then a first mid-frame blanking interval is generated. Following this first mid-frame blanking interval, a second portion of the frame is driven to the display, followed by a second mid-frame blanking interval, followed by a third portion of the frame, and so on. Any number of mid-frame blanking intervals may be introduced in a given frame. During each mid-frame blanking interval, touch sensing is performed to detect touch events on the screen for in-cell touch type displays. For displays with touch sensors electrically separated from the display common voltage layer, special sense scan steps are performed during mid-frame blanking intervals. By performing touch sensing or special sense scan steps during a frame rather than only at the end of a frame, the performance of touch sensing is improved.

### BACKGROUND

1. Technical Field

Embodiments described herein relate to driving a display, and more particularly, to performing mid-frame blanking when driving a display.

2. Description of the Related Art

Mobile devices such as smartphones and tablets are being used for an increasing variety of end-user applications. A mobile device is a small, handheld computing device typically having a display screen with touch input. A handheld computing device has an operating system and can run various types of application software (i.e., apps). Mobile devices are useful for people who need to use some of the functionality of a conventional computer in environments where carrying one would be impractical. Most mobile devices utilize a touch screen interface for allowing the user to interface and control the mobile device. The responsiveness and ease of use of the touch screen interface is a big part of the user experience.

For in-cell touch type displays or other similar touch screen displays, the touch sensor is integrated with or closely coupled to the display common voltage layer, and actively driving pixels can interfere with the ability to perform touch sensing on the display. Accordingly, for these types of displays, touch sensing is typically performed in the vertical blanking period between frames. However, this limits the frequency of touch sensing to the frame refresh rate. For non in-cell touch type displays or other similar type touch screen displays, a display integrated touch sensor that is electrically separated from the display common voltage layer may provide the ability to perform a touch scan while a display refresh is ongoing. Even for these types of displays, certain special sense scan steps may be conducted during display blanking, as active display refresh can cause noise interference which could degrade performance. Examples of these scan steps include stylus scans, mutual capacitance scans, and self capacitance scans.

In some cases, applications running on a touch screen device may require or benefit from a higher touch sensing frequency compared with display frame refresh rate. For example, a user may be applying their signature to a tablet using a stylus. In such a case, an increase in the touch sensing frequency would allow the signature to be captured with increased accuracy.

It is noted that the term “touch sensing” is intended to encompass detecting and capturing any of various types of sense inputs. Accordingly, as used herein, the term “touch sensing” may refer to detecting any of various types of user interactions with a touch screen display, including detecting the location, force, and type of user input or interaction with the display, wherein the interaction may take the form of the touch of one or more fingers, styli, or other instruments, as well as other types of interactions with the screen and/or other measurements (e.g., force, tilt) associated with these interactions. It is also noted that the term “touch sensitive display” refers to a display which has the ability to detect any of these various types of user interactions and capture any of various types of measurements based on these interactions.

### SUMMARY

Systems, apparatuses, and methods for performing mid-frame blanking are disclosed.

In various embodiments, a device includes a display, a display pipeline, and a touch sensor integrated with the display. Source frame pixels may be processed by the display pipeline and presented as destination frames on the display. For some types of displays (e.g., in-cell touch displays), while the display pipeline is actively driving output pixels to the display, the touch sensor may not be able to perform touch sensing to detect touch events on the screen. Accordingly, the touch sensor may be configured to perform touch sensing when the display pipeline is not actively driving the display. However, this may limit the frequency of how often touch sensing may be performed and may inhibit the performance of the touch sensing. For other types of displays, when the touch sensor is electrically separated from the display common voltage layer, a touch scan may be performed while a display refresh is ongoing. For these types of displays, certain special sense scan steps (e.g., stylus scans, mutual capacitance scans, self capacitance scans) may be conducted during display blanking.

In order to increase the frequency of touch sensing without increasing the frame refresh rate, touch sensing may be performed more than once per display frame. This fine grain touch sensing may be performed in cases when the use of a pen, stylus, detecting force, or other touch instruments on the screen are detected. For example, an application may generate a signature field with the expectation that a user will sign their name in the signature field. In such an embodiment, the system may be configured to increase the frequency of touch sensing by performing mid-frame blanking responsive to detecting execution of the application. In other embodiments, other events may trigger an increase in the frequency of touch sensing by causing the display pipeline to perform mid-frame blanking. However, in other embodiments, mid-frame blanking may be performed on a continuous basis and may be available for the touch subsystem to use if needed.

To perform mid-frame blanking, the display pipeline may interrupt the vertical active period (“active period”) of frames being driven to the display and introduce a mid-frame blanking interval after a first portion of the frame has been displayed. Then, after this mid-frame blanking interval has expired, the next portion of the frame may be driven to the display, after which another mid-frame blanking interval may be introduced. Any number of mid-frame blanking intervals may be introduced within a given frame, with the higher the number of mid-frame blanking intervals, the higher the frequency of touch sensing that can be performed.

These and other features and advantages will become apparent to those of ordinary skill in the art in view of the following detailed descriptions of the approaches presented herein.

### BRIEF DESCRIPTION OF THE DRAWINGS

The above and further advantages of the methods and mechanisms may be better understood by referring to the following description in conjunction with the accompanying drawings, in which:

FIG. 1 is a block diagram illustrating one embodiment of a system on chip (SOC) coupled to a memory and one or more display devices.

FIG. 2 is a block diagram illustrating one embodiment of a display pipeline.

FIG. 3 is a block diagram illustrating one embodiment of control logic for implementing mid-frame blanking.

FIG. 4 is a block diagram illustrating one embodiment of the implementation of mid-frame blanking intervals within a given frame.

FIG. 5 is a block diagram illustrating one embodiment of frame components utilized when performed mid-frame blanking.

FIG. 6 illustrates one embodiment of a timing diagram of performing mid-frame blanking.

FIG. 7 is a generalized flow diagram illustrating one embodiment of a method for performing mid-frame blanking.

FIG. 8 is a generalized flow diagram illustrating one embodiment of a method for determining when to increase the touch sensing frequency of a touch sensitive display.

FIG. 9 is a block diagram of one embodiment of a system.

FIG. 10 illustrates adjusting the frame refresh rate using mid-frame blanking.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

This specification includes references to “one embodiment”. The appearance of the phrase “in one embodiment” in different contexts does not necessarily refer to the same embodiment. Particular features, structures, or characteristics may be combined in any suitable manner consistent with this disclosure. Furthermore, as used throughout this application, the word “may” is used in a permissive sense (i.e., meaning having the potential to), rather than the mandatory sense (i.e., meaning must). Similarly, the words “include”, “including”, and “includes” mean including, but not limited to.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “An apparatus comprising a display pipeline . . . . ” Such a claim does not foreclose the apparatus from including additional components (e.g., a processor, a memory controller).

“Configured To.” Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, paragraph (f), for that unit/circuit/component. Additionally, “configured to” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

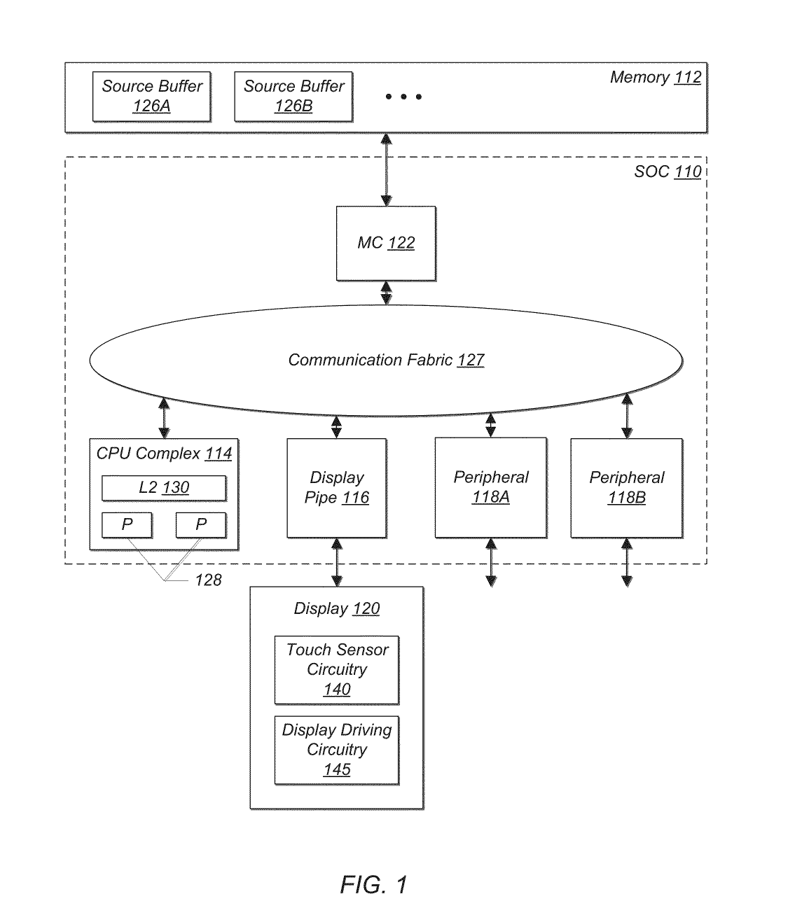

Referring now to FIG. 1, a block diagram of one embodiment of a system on chip (SOC) 110 is shown coupled to a memory 112 and display device 120. A display device may be more briefly referred to herein as a display. As implied by the name, the components of the SOC 110 may be integrated onto a single semiconductor substrate as an integrated circuit “chip.” In some embodiments, the components may be implemented on two or more discrete chips in a system. However, the SOC 110 will be used as an example herein. In the illustrated embodiment, the components of the SOC 110 include a central processing unit (CPU) complex 114, a display pipe 116, peripheral components 118A-118B (more briefly, “peripherals”), a memory controller 122, and a communication fabric 127. The components 114, 116, 118A-118B, and 122 may all be coupled to the communication fabric 127. The memory controller 122 may be coupled to the memory 112 during use. Similarly, the display pipe 116 may be coupled to the display 120 during use. In the illustrated embodiment, the CPU complex 114 includes one or more processors 128 and a level two (L2) cache 130.

The display pipe 116 may include hardware to process one or more still images and/or one or more video sequences for display on the display 120. Generally, for each source still image or video sequence, the display pipe 116 may be configured to generate read memory operations to read the data representing the frame/video sequence from the memory 112 through the memory controller 122.

The display pipe 116 may be configured to perform any type of processing on the image data (still images, video sequences, etc.). In one embodiment, the display pipe 116 may be configured to scale still images and to dither, scale, and/or perform color space conversion on the frames of a video sequence. The display pipe 116 may be configured to blend the still image frames and the video sequence frames to produce output frames for display. The display pipe 116 may also be more generally referred to as a display pipeline, display control unit, or a display controller. A display control unit may generally be any hardware configured to prepare a frame for display from one or more sources, such as still images and/or video sequences.

More particularly, the display pipe 116 may be configured to retrieve source frames from one or more source buffers 126A-126B stored in the memory 112, composite frames from the source buffers, and display the resulting frames on the display 120. Source buffers 126A and 126B are representative of any number of source buffers which may be stored in memory 112. Accordingly, display pipe 116 may be configured to read the multiple source buffers 126A-126B and composite the image data to generate the output frame.

The display 120 may be any sort of visual display device. The display may be, for example, a touch screen style display for mobile devices such as smart phones, tablets, etc. The display 120 may be a liquid crystal display (LCD), light emitting diode (LED), plasma, cathode ray tube (CRT), etc. The display 120 may be integrated into a system including the SOC 110 (e.g. a smart phone or tablet) and/or may be a separately housed device such as a computer monitor, television, or other device.

In some embodiments, the display 120 may be directly connected to the SOC 110 and may be controlled by the display pipe 116. That is, the display pipe 116 may include hardware (a “backend”) that may provide various control/data signals to the display, including timing signals such as one or more clocks and/or the vertical blanking period and horizontal blanking interval controls. The clocks may include the pixel clock indicating that a pixel is being transmitted. The data signals may include color signals such as red, green, and blue, for example. The display pipe 116 may control the display 120 in real-time, providing the data indicating the pixels to be displayed as the display is displaying the image indicated by the frame. The interface to such display 120 may be, for example, VGA, HDMI, digital video interface (DVI), a liquid crystal display (LCD) interface, a plasma interface, a cathode ray tube (CRT) interface, any proprietary display interface, etc.

Display 120 may include touch sensor circuitry 140 and display driving circuitry 145. Touch sensor circuitry 140 may include circuitry and logic for sensing touch events on display 120 and conveying information regarding detected touch events to SOC 110. Touch sensor circuitry 140 may be configured to detect the presence and location of a touch or the proximity of an object within a touch-sensitive area of a touch sensor overlaid on the screen of display 120. Touch sensor circuitry 140 may utilize any combination of sensor components and sensing technologies to detect touch events on touch sensitive display 120. Display driving circuitry 145 may include circuitry and logic for driving pixels onto the display 120. In one embodiment, touch sensor circuitry 140 and display driving circuitry 145 may be integrated into a single panel or layer. In another embodiment, touch sensor circuitry 140 and display driving circuitry 145 may be stacked together in separate layers.

In some embodiments, when using an in-cell touch type display or other similar touch screen display, touch sensor circuitry 140 may be susceptible to interference and malfunctioning if display driving circuitry 145 is driving pixels to display 120 simultaneously with touch sensor circuitry 140 attempting to detect touch events. Therefore, in these embodiments, touch sensor circuitry 140 may perform touch sensing only when display driving circuitry 145 is not driving pixels to display 120. Therefore, touch sensing is typically performed in the vertical blanking period in between frames. However, certain applications may benefit from a touch sensing frequency of greater than once per frame. In order to increase the touch sensing frequency, mid-frame blanking may be performed to interrupt the vertical active period (referred to herein as “active period”) when display driving circuitry 145 is actively driving pixels to display 120 and insert mid-frame blanking intervals in between writing portions of the same frame to display 120. In other embodiments, when the touch sensor circuitry 140 is electrically separated from the display driving circuitry 145, a touch scan may be performed while a display refresh is ongoing. Even in these embodiments, certain special sense scan steps (e.g., stylus scans, mutual capacitance scans, self capacitance scans) may be conducted during mid-frame blanking intervals, as active display refresh can cause noise interference degrading performance.

Accordingly, frames may be displayed on display 120 at a first frame rate. As a result of implementing mid-frame blanking, touch sensing may be performed on the display 120 at a second rate which is at a higher frequency than the first frame rate. In other words, the time between consecutive active touch sensing intervals of touch sensor 140 may be less than one frame period. For example, in one embodiment, frames may be displayed on display 120 at a frame rate of 60 frames per second. Touch sensing may be performed 240 times per second, which is four times faster than the frame rate. Touch sensing may be performed four times faster than the frame rate by introducing three mid-frame blanking intervals per frame such that touch sensing is performed at three separate intervals within each frame and also at the end of each frame. For example, a stylus scan may be performed at a rate 240 hertz (Hz) or higher, and a stylus scan may be performed during mid-frame blanking intervals even in cases when the touch sensor circuitry 140 is electrically separated from the display driving circuitry 145. Other embodiments may utilize other frame rates, other numbers of mid-frame blanking intervals, and have other ratios between the touch sensing and frame rate frequencies such that the touch sensing frequency is a multiple of the frame rate.

The CPU complex 114 may include one or more CPU processors 128 that serve as the CPU of the SOC 110. The CPU of the system includes the processor(s) that execute the main control software of the system, such as an operating system. Generally, software executed by the CPU during use may control the other components of the system to realize the desired functionality of the system. The CPU processors 128 may also execute other software, such as application programs. The application programs may provide user functionality, and may rely on the operating system for lower level device control. Accordingly, the CPU processors 128 may also be referred to as application processors. The CPU complex may further include other hardware such as the L2 cache 130 and/or an interface to the other components of the system (e.g., an interface to the communication fabric 127).

The peripherals 118A-118B may be any set of additional hardware functionality included in the SOC 110. For example, the peripherals 118A-118B may include video peripherals such as video encoder/decoders, image signal processors for image sensor data such as camera, scalers, rotators, blenders, graphics processing units, etc. The peripherals 118A-118B may include audio peripherals such as microphones, speakers, interfaces to microphones and speakers, audio processors, digital signal processors, mixers, etc. The peripherals 118A-118B may include interface controllers for various interfaces external to the SOC 110 including interfaces such as Universal Serial Bus (USB), peripheral component interconnect (PCI) including PCI Express (PCIe), serial and parallel ports, etc. The peripherals 118A-118B may include networking peripherals such as media access controllers (MACs). Any set of hardware may be included.

The memory controller 122 may generally include the circuitry for receiving memory operations from the other components of the SOC 110 and for accessing the memory 112 to complete the memory operations. The memory controller 122 may be configured to access any type of memory 112. For example, the memory 112 may be static random access memory (SRAM), dynamic RAM (DRAM) such as synchronous DRAM (SDRAM) including double data rate (DDR, DDR2, DDR3, etc.) DRAM. Low power/mobile versions of the DDR DRAM may be supported (e.g. LPDDR, mDDR, etc.). The memory controller 122 may include various queues for buffering memory operations, data for the operations, etc., and the circuitry to sequence the operations and access the memory 112 according to the interface defined for the memory 112.

The communication fabric 127 may be any communication interconnect and protocol for communicating among the components of the SOC 110. The communication fabric 127 may be bus-based, including shared bus configurations, cross bar configurations, and hierarchical buses with bridges. The communication fabric 127 may also be packet-based, and may be hierarchical with bridges, cross bar, point-to-point, or other interconnects.

It is noted that the number of components of the SOC 110 (and the number of subcomponents for those shown in FIG. 1, such as within the CPU complex 114) may vary from embodiment to embodiment. There may be more or fewer of each component/subcomponent than the number shown in FIG. 1. It is also noted that SOC 110 may include many other components not shown in FIG. 1. In various embodiments, SOC 110 may also be referred to as an integrated circuit (IC), an application specific integrated circuit (ASIC), or an apparatus.

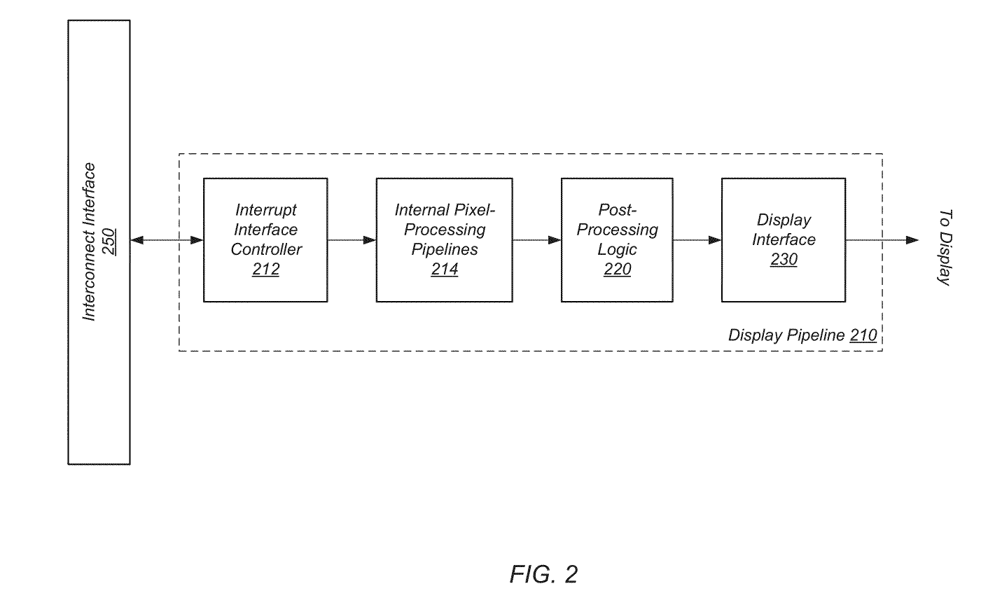

Turning now to FIG. 2, a generalized block diagram of one embodiment of a display pipeline 210 is shown. The display pipeline 210 may be coupled to an interconnect interface 250 and a display (not shown). In one embodiment, display pipeline 210 may send rendered graphical information to the display. The interconnect interface 250 may include multiplexers and control logic for routing signals and packets between the display pipeline 210 and a top-level fabric. The interconnect interface 250 may correspond to communication fabric 127 of FIG. 1.

Display pipeline 210 may include interrupt interface controller 212. The interrupt interface controller 212 may include logic to expand a number of sources or external devices to generate interrupts to be presented to the internal pixel-processing pipelines 214. The controller 212 may provide encoding schemes, registers for storing interrupt vector addresses, and control logic for checking, enabling, and acknowledging interrupts. The number of interrupts and a selected protocol may be configurable.

Display pipeline 210 may include one or more internal pixel-processing pipelines 214. The internal pixel-processing pipelines 214 may include one or more ARGB (Alpha, Red, Green, Blue) pipelines for processing and displaying user interface (UI) layers. The internal pixel-processing pipelines 214 may also include one or more pipelines for processing and displaying video content such as YUV content. In some embodiments, internal pixel-processing pipelines 214 may include blending circuitry for blending graphical information before sending the information as output to post-processing logic 220.

The display pipeline 210 may include post-processing logic 220. The post-processing logic 220 may be used for color management, ambient-adaptive pixel (AAP) modification, dynamic backlight control (DPB), panel gamma correction, and dither. The post-processing logic 220 may also include logic configured to perform mid-frame blanking during the vertical active periods of frames being displayed. The display interface 230 may handle the protocol for communicating with the internal panel display. For example, the Mobile Industry Processor Interface (MIPI) Display Serial Interface (DSI) specification may be used. Alternatively, a 4-lane Embedded Display Port (eDP) specification may be used. The post-processing logic 220 and display interface 230 may also be referred to as the display backend.

The post-processing logic 220 may be configured to interrupt the vertical active period by inserting one or more mid-frame blanking intervals within each frame being displayed. Display pipeline 210 may include control logic for determining when to insert a mid-frame blanking interval within a given frame and the duration of the mid-frame blanking interval. In one embodiment, a line counter may be implemented to support blanking in the middle of a frame. Both the start position and the duration of the blanking may be programmable. When the starting position is reached, the horizontal synchronization and data enable signals for the pixel processing blocks of the display pipeline 210 may be masked for the duration of the blanking. However, the horizontal synchronization and data enable signals being driven to display interface 230 may still be generated and dummy pixels may be provided to display interface 230. In various embodiments, the generated dummy pixels may be programmable.

The pixel processing blocks of display pipeline 210 may be stalled during the mid-frame blanking. The display interface 230 may receive the dummy pixels in the same manner as if they were regular pixels. In this way, mid-frame blanking may be transparent to the display interface 230. Logic within the display interface 230 may be notified of the programming of the mid-frame blanking period so as to discard or ignore the dummy pixels.

In one embodiment, mid-frame blanking may be enabled by programming a set of parameters (e.g., midporch position, midporch width) to take effect during the vertical active period. The parameters midporch width and midporch position may be expressed in units of line count. Multiple mid-frame blanking intervals may be programmed to take effect during a single frame. In one embodiment, a buffer may be implemented which can hold up to ‘N’ sets of programmable mid-frame blanking interval values, wherein ‘N’ is a positive integer which varies according to the embodiment. The start position of subsequent sets may be monotonically increasing, as the line counter increases monotonically.

In one embodiment, line count may start with the value ‘0’ at the beginning of the vertical active region and may increase by ‘1’ every line until the end of the vertical active region. The vertical active period may be expressed in terms of a number of lines and may be programmed to a value that includes the total number of midporch widths. In one embodiment, the midporch positions may increase strictly monotonically according to this formula: midporch position [n+1]>midporch position [n]+midporch width [n]>0.

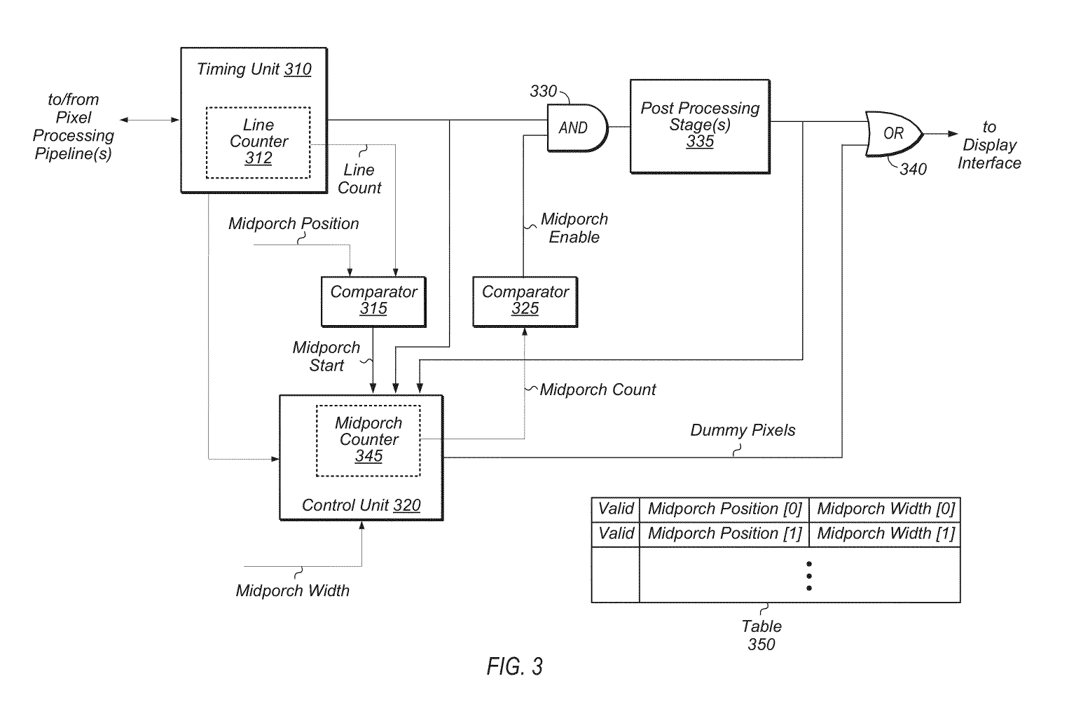

Referring now to FIG. 3, a block diagram of one embodiment of control logic for implementing mid-frame blanking is shown. The control logic of the display pipeline (e.g., display pipeline 210) may include timing unit 310, which may be configured to receive pixel data from the pixel processing pipeline(s) (not shown) and generate vertical and horizontal timing signals. In one embodiment, timing unit 310 may be configured to retrieve pixels from a first-in first-out buffer (FIFO) (not shown) at the output of the pixel processing pipeline(s). The pixel processing pipeline(s) may be configured to push pixels into the FIFO at a variable rate. In one embodiment, timing unit 310 may be configured to pop pixels from the FIFO at a fixed rate determined by the horizontal timing signals.

Timing unit 310 may also be configured to generate a horizontal synchronization signal for controlling the data pipe stages of the display pipeline. The horizontal synchronization signal and pixels retrieved from the FIFO may be coupled to post-processing stage(s) 335 via AND gate 330. Post-processing stage(s) 335 may include one or more of color management, ambient-adaptive pixel (AAP) modification, dynamic backlight control (DPB), panel gamma correction, dither, and other stages.

The control logic may also include table 350 which stores mid-frame (or midporch) position and width values for any number of mid-frame blanking intervals which are to be inserted into frames being displayed. Table 350 may be programmable via control software executing on a processor (e.g., processor 128 of FIG. 1) of the host device. Table 350 may include any number of entries for storing midporch position and width values and each entry may include a valid bit to indicate if the values in the entry should be used for inserting a mid-frame blanking interval in the vertical active period of the frame. Table 350 is representative of any type of logic or structure (e.g., buffer, register) which may be used for storing the midporch position and width values.

At the start of each frame, if the first entry is valid, the control logic may load the midporch position and width values (i.e., midporch position [0] and midporch width [0]) from the first entry of table 350. The control logic may utilize the midporch position to determine where to insert the first mid-frame blanking interval and the control logic may utilize the midporch width to determine how long the mid-frame blanking interval should last. After the first mid-frame blanking interval has expired, the control logic may determine if the next entry is valid, and if so, then the control logic may utilize the midporch position value of this entry (i.e., midporch position [1]) to determine when to insert the next mid-frame blanking interval. The control logic may continue inserting a new mid-frame blanking interval for each additional valid entry in table 350. When the control logic detects that the next entry in table 350 is invalid, then no additional mid-frame blanking intervals will be inserted for the current frame.

Timing unit 310 may include (or be coupled to) line counter 312 which is configured to track the number of lines that have been displayed for the current frame. In order to determine when to insert a mid-frame blanking interval into the vertical active period of the current frame, the line count output from line counter 312 may be conveyed to comparator 315. Comparator 315 may compare the current line count value to the current midporch position value. Comparator 315 may generate a trigger (Midporch Start) when the current line count is equal to the midporch position, and the Midporch Start signal may be coupled to control unit 320.

Control unit 320 may be configured to generate dummy pixels and synchronization signals when the trigger ‘Midporch Start’ indicates the start of a mid-frame blanking interval. The dummy pixels may take on any suitable values (e.g., all zeroes), and the dummy pixels may be dropped by the display interface (not shown) rather than being driven to the display. Control unit 320 may also receive horizontal timing and synchronization signals generated by timing unit 310. Additionally, timing signals generated by the post processing stage(s) 335 may be coupled to control unit 320. Control unit 320 may also receive the current midporch width value from table 350. Control unit 320 may also include (or be coupled to) midporch counter 345 which may be configured to generate the signal ‘Midporch Count’ which is coupled to comparator 325. When a mid-frame blanking interval is initiated, midporch counter 345 may be set to the current midporch width value. Then, for each line of dummy pixels that are generated during the mid-frame blanking interval, midporch counter 345 may be decremented. The dummy pixels generated by control unit 320 and horizontal timing and synchronization signals may be conveyed through OR gate 340 to the display interface. Additionally, the signal ‘Midporch Enable’ may be conveyed to the display interface so that the display interface can drop the dummy pixels during the mid-frame blanking interval rather than send them to the display.

In one embodiment, comparator 325 may compare ‘Midporch Count’ to 0. When ‘Midporch Count’ is greater than 0, then comparator 325 may drive the signal ‘Midporch Enable’ high to AND gate 330, which will stall (or clock-gate) the data processing blocks in post-processing stage(s) 335. When ‘Midporch Count’ is equal to 0 (indicating the end of the mid-frame blanking interval), then comparator 325 may drive the signal ‘Midporch Enable’ low to AND gate 330, which will cause the data processing blocks in post-processing stage(s) 335 to be turned back on. The signal ‘Midporch Enable’ may also be coupled to other logic and stages (e.g., pixel processing pipelines) to allow the other logic and stages to be stalled, clock-gated, or power-gated during the mid-frame blanking interval.

The latency through post-processing stage(s) 335 may vary depending on which stages are activated. However, the latency may be constant for a given application scenario. In one embodiment, the latency of control unit 320 may be configured to match the latency of data pipe stages 335. When control unit 320 is inactive (when mid-frame blanking is not being performed), a counter (not shown) may measure the latency between the input of post-processing stage(s) 335 and the output of post-processing stage(s) 335. When ‘Midporch Start’ is triggered at the start of a mid-frame blanking interval, the measured latency may be captured in a register (not shown). Control unit 320 may then utilize this measured latency to generate output signals which match the latency of post-processing stage(s) 335.

It is noted that FIG. 3 is merely one example of the arrangement of logic which may be utilized within the display pipeline to generate mid-frame blanking intervals. Other embodiments may include other control logic and may be arranged in other suitable manners.

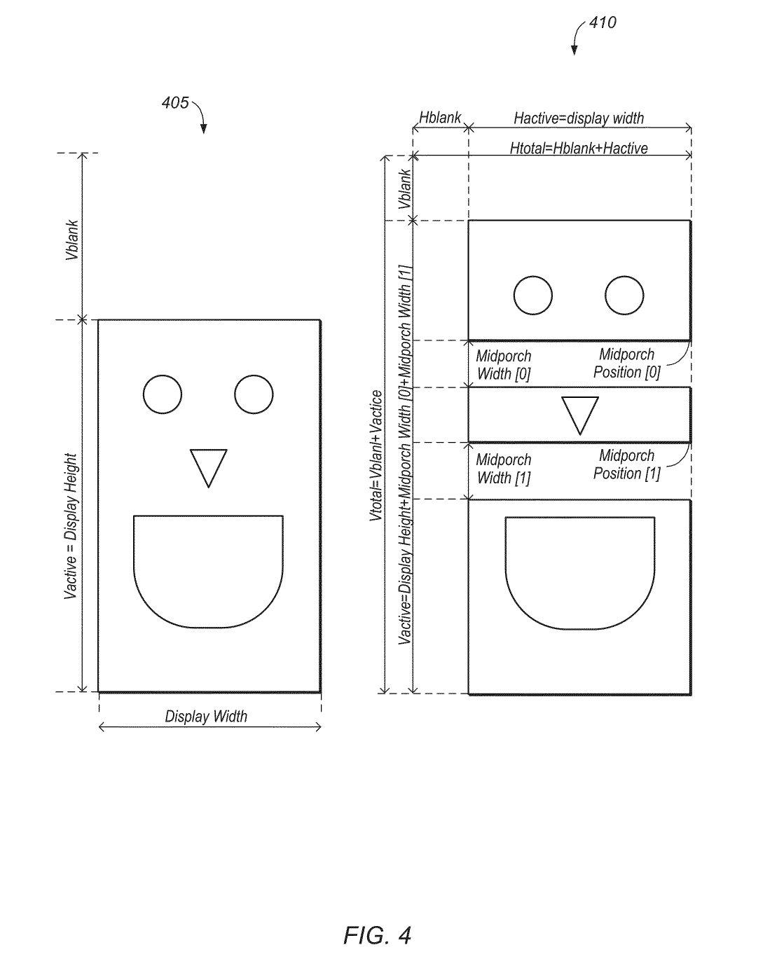

Turning now to FIG. 4, a block diagram of one embodiment of the implementation of mid-frame blanking intervals within a given frame 410 is shown. Frame 405 is an example of an image or video frame which may be written to a display without the use of mid-frame blanking intervals. Frame 410 illustrates the same source image as shown in frame 405, but this time with the use of two mid-frame blanking intervals introduced within frame 410.

The mid-frame blanking intervals are inserted into the vertical active period of frame 410 at the locations denoted by midporch position [0] and midporch position [1]. It is noted that the use of two mid-frame blanking intervals within frame 410 is shown for illustrative purposes only. In other embodiments, other numbers of mid-frame blanking intervals may be utilized.

In one embodiment, the frame period used when displaying frames without mid-frame blanking intervals may be the same as the frame period used when displaying frames with mid-frame blanking intervals. For example, as shown in FIG. 4, the sum of the vertical blanking period and vertical active period for frame 405 may be equal to the sum of the vertical blanking period and vertical active period for frame 410. Therefore, since two mid-frame blanking intervals were added to the vertical active period of frame 410, the vertical blanking period of frame 410 may be decreased by the sum of the width of these two mid-frame blanking intervals. For frame 405, the sum of the single vertical blanking period and the single vertical active period is equal to Vtotal, or one frame time. Similarly, for frame 410, the sum of the vertical blanking period, the three periods of display driving of the three portions of the frame, and the width of the two mid-frame blanking intervals is also equal to Vtotal.

Generally speaking, the single vertical blanking period and single vertical active period of frame 405 are broken up into smaller pieces which are distributed throughout the entire frame time of frame 410. Accordingly, the sum of the vertical blanking period and mid-frame blanking intervals of frame 410 are equal to the single vertical blanking period of frame 405. In this manner, the overall frame rate may generally remain unchanged. In one embodiment, a vertical active signal may remain asserted during the mid-frame blanking intervals. Within the display backend, this may be accomplished by extending horizontal blanking. It is noted that the term “equal” as used above in relation to time periods is not necessarily intended to mean identical to a degree that no difference is possibly discernible. Rather, differences associated with particular technologies are possible and are contemplated. For example, to say that two time periods are equal assumes there may be slight variations due to signal noise, jitter, clock skew, or otherwise. However, such differences are, for the most part, within design constraints and are not sufficient to disrupt the intended operation of the device.

In one embodiment, when the display integrated touch sensor is not isolated from the display common voltage layer, the mid-frame blanking intervals may be inserted into frame 410 to increase the frequency of touch sensing which can be performed on a corresponding touch sensitive display. During each mid-frame blanking interval, touch sensing may be performed on the display. Additionally, touch sensing may be performed during the vertical blanking period before the start of each frame when the display is not being actively driven. In other embodiments, when the display integrated touch sensor is electrically separated from the display common voltage layer, a touch scan may be performed during active display refresh and special scan steps may be performed during vertical and mid-frame blanking. These special scan steps may include stylus scans, mutual capacitance scans and self capacitance scans. In various embodiments, mid-frame blanking may be triggered in response to detecting an event. For example, detection of an event may be responsive to an application that requests (or may otherwise require) an increased touch sense frequency, detecting pressure, detecting a touch, detecting force, detecting movement from one touch position to another, detecting repeated touches within a given time period, or detecting any other condition or signal. In various embodiments, mid-frame blanking may be enabled by default. Numerous such embodiments are possible and are contemplated.

As shown in FIG. 4, frames 405 and 410 have the same display width, which corresponds to the horizontal active (or Hactive) period shown for frame 410. Prior to the Hactive period for each line is the horizontal blanking (or Hblank) period as shown for frame 410. Similarly, prior to the vertical active (or Vactive) period for frame 410 (i.e., after the vertical active period for the previous frame) is the vertical blanking (or Vblank) period. The horizontal blanking period is the period from when the last pixel of a horizontal line is drawn on the display to when the first pixel of the next horizontal line is drawn on the display. The vertical blanking period is the period from when the last pixel of a frame is drawn on the display to when the first pixel of the next frame is drawn on the display. The vertical active period is the period from when the first pixel of a given frame is drawn on the display to when the last pixel of the given frame is drawn on the display. The vertical active period may also be referred to as the time allotted for driving the display. The vertical active period and vertical blanking period may be measured in lines, while the horizontal active period and horizontal blanking period may be measured in pixels.

When mid-frame blanking intervals are utilized for a given frame, then the vertical active period may include both the display height of the frame plus one or more midporch widths. Accordingly, the vertical active period may be equal to the display height plus the sum of midporch widths corresponding to the mid-frame blanking intervals introduced during the frame. For frame 410, the vertical active period equals the display height plus midporch width [0] plus midporch width [1].

In one embodiment, the vertical timing may be chosen such that the active and blanking periods add up to a constant period for a given refresh rate (e.g., 1/(60 hertz)). In one embodiment, the time for the mid-frame blanking intervals may be taken away from the time otherwise available for the vertical blanking period. Accordingly, the vertical blanking period may be reduced to account for the mid-frame blanking interval(s) that are introduced for each frame. It is noted that in some embodiments, the timing and duration of frame parameters may be chosen such that the vertical blanking periods and mid-frame blanking intervals are of the same duration and spaced at regular intervals in time. It is also noted that the vertical blanking period may include a vertical front porch, vertical sync pulse, and a vertical back porch. Similarly, the horizontal blanking period may include a horizontal front porch, a horizontal sync pulse, and a horizontal back porch.

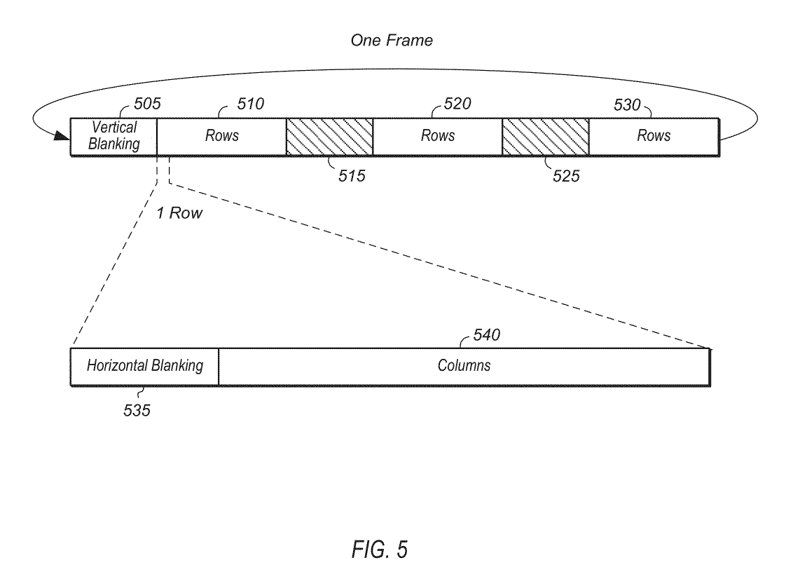

Referring now to FIG. 5, a block diagram of one embodiment of frame components when implementing mid-frame blanking intervals is shown. The vertical components of a single frame are shown at the top of FIG. 5, and the components include vertical blanking period 505, rows 510 from a first portion of the frame, a first mid-frame blanking interval 515, rows 520 from a second portion of the frame, a second mid-frame blanking interval 525, rows 530 from a third portion of the frame. It is noted that these two mid-frame blanking intervals 515 and 525 are representative of any number of mid-frame blanking intervals which may be inserted into the display of a given frame.

Each frame may begin with a vertical blanking period 505 during which touch sensing may be performed on a corresponding touch-screen display. Touch sensing may also be performed during both mid-frame blanking intervals 515 and 525. If the frame rate was running at 60 hertz (Hz) in one embodiment, then by introducing the two mid-frame blanking intervals 515 and 525, touch sensing could be performed at 180 Hz, dramatically increasing the frequency of touch sensing, thereby improving the performance of the touch sensing.

A single row of frame rows 510 is shown expanded in the bottom of FIG. 5 to illustrate the horizontal components of the row. The expanded row begins with a horizontal blanking period 535 followed by the pixels of columns 540 being displayed. This horizontal timing may be repeated for each row of the frame until either a mid-frame blanking interval is introduced or until the bottom of the frame has been reached.

In one embodiment, vertical blanking period 505 and mid-frame blanking intervals 515 and 525 may be chosen such that they are of the same duration. Also, the locations of vertical blanking period 505 and mid-frame blanking intervals 515 and 525 may be chosen such that they are spaced at fixed, regular intervals in time so that touch sensing can be performed at a constant frequency.

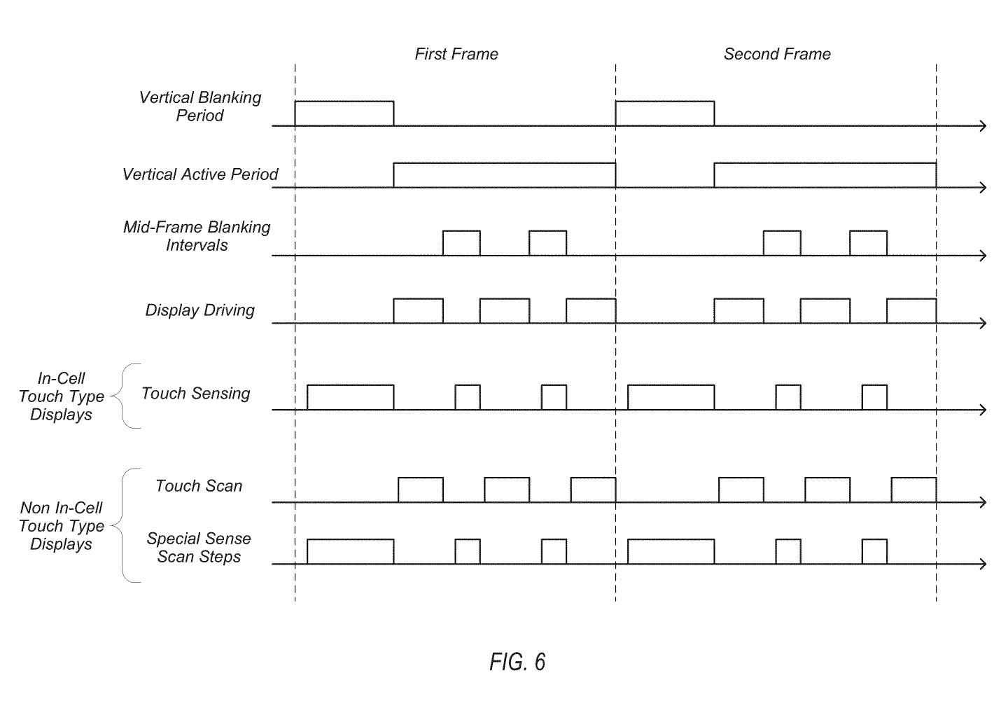

Turning now to FIG. 6, one embodiment of a timing diagram of performing mid-frame blanking is shown. The start of the first frame and the start of the second frame when no pixels are being driven to the display may be referred to as the vertical blanking period. The time of a frame not spent in the vertical blanking period may be referred to as the vertical active period. During the vertical blanking period, touch sensing may be performed as shown at the bottom of FIG. 6. At the start of the vertical blanking period, the device may wait for a short period of time to elapse prior to performing touch sensing to allow for voltage settling and/or to prevent any residual noise from interfering with the touch sensing.

As shown in FIG. 6, the pixels of the first frame are driven in three separate intervals, with a portion of the first frame being written to the display in each interval. After the first portion of the frame is driven to the display, a first mid-frame blanking interval may be inserted during which the display pipeline may stall and stop driving pixels to the display. During this first mid-frame blanking interval, portions of the display pipeline may be clock-gated while dummy pixels are generated in place of actual pixels.

After the first mid-frame blanking interval, the display pipeline may wake up and drive a second portion of the frame to the display. After driving the second portion of the first frame to the display, the display pipeline may stop driving the display during the second mid-frame blanking interval and clock-gate portions of the display pipeline while generating dummy pixels. After the second mid-frame blanking interval, the display pipeline may drive the third portion of the first frame to the display.

The same timing of display driving and mid-frame blanking intervals used for the first frame may be continued for the second frame. This pattern of frame timing may continue indefinitely until the midporch location and width values are changed via software. The example of frame timing shown in FIG. 6 is merely one example of frame timing that may be utilized when performing mid-frame blanking. It is to be understood that other embodiments may utilize other numbers of mid-frame blanking intervals and/or may have alternate timing parameters.

For in-cell touch type displays, touch sensing may be performed only when the display is not being actively driven. As such, touch sensing may be performed during the vertical blanking period as shown for the waveform labeled “In-Cell Touch Type Displays”. At the start of the vertical blanking period, the device may wait for a short period of time to elapse prior to performing touch sensing to allow for voltage settling and/or to prevent any residual noise from interfering with the touch sensing. Also for in-cell touch type displays, touch sensing may be performed during the first and second mid-frame blanking intervals.

For non in-cell touch type displays where the display integrated touch sensor is electrically separated from the display common voltage layer, touch scans may be performed at any time during the frame whether or not the display is being actively driven. This is shown in the waveform labeled “Non In-Cell Touch Type Displays” at the bottom of FIG. 6. However, certain special sense scan steps may be conducted during the vertical blanking period and mid-frame blanking intervals. Examples of these scan steps include stylus scans, mutual capacitance scans, and self capacitance scans. For these non in-cell touch types of displays, different types of scans may be performed depending on the mode in which the display is operating. For example, a touch scan may be performed to detect touch events caused by one or more fingers while the device is in touch mode. Alternatively, a stylus scan may be performed while in stylus mode to receive data transmitted by a stylus.

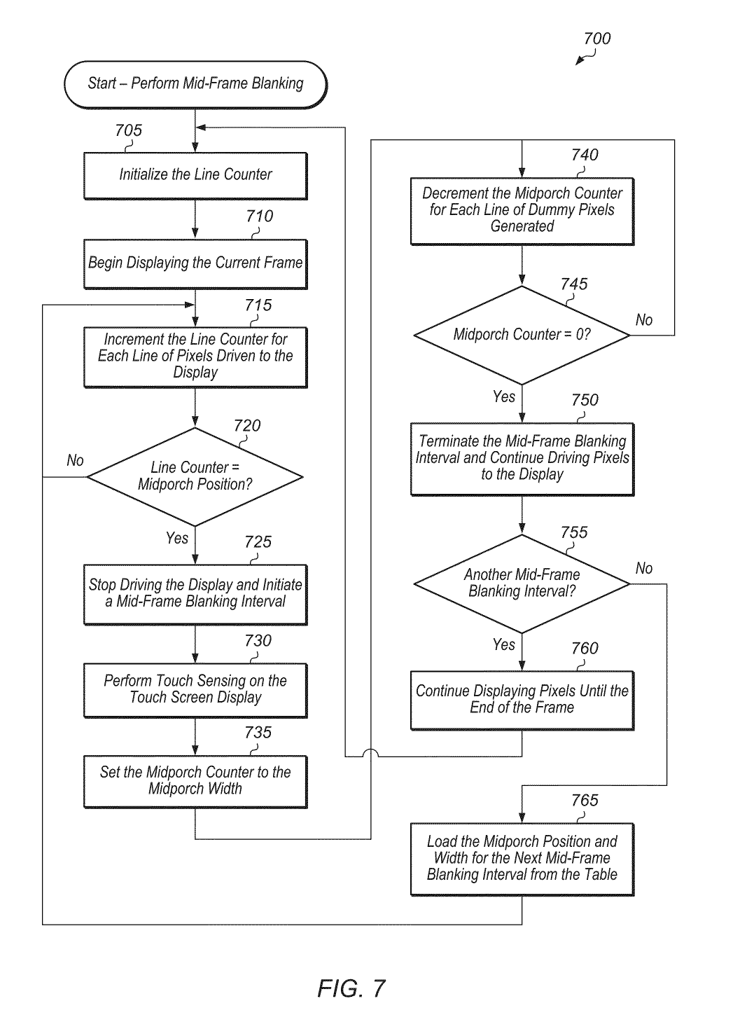

Referring now to FIG. 7, one embodiment of a method 700 for performing mid-frame blanking is shown. For purposes of discussion, the steps in this embodiment are shown in sequential order. It should be noted that in various embodiments of the method described below, one or more of the elements described may be performed concurrently, in a different order than shown, or may be omitted entirely. Other additional elements may also be performed as desired. Any of the various devices and display pipelines described herein may be configured to implement method 700.

At the start of processing a frame for display, a display pipeline may initialize a line counter (block 705). The line counter may track the number of lines of pixels that have been generated for the current frame. Next, the display pipeline may begin displaying the current frame (block 710). While the pixels of the current frame are being displayed, the line counter may be incremented for each line of pixels that is driven to the display (block 715).

Then, the display pipeline may determine if the line counter is equal to the current midporch position (conditional block 720). The current midporch position refers to the midporch value stored in the current entry of the table with mid-frame blanking interval values. If the line counter is not equal to the midporch position (conditional block 720, “no” leg), then method 700 may return to block 715. If the line counter is equal to the midporch position (conditional block 720, “yes” leg), then the display pipeline may stop driving the display and initiate a mid-frame blanking interval (block 725). During the mid-frame blanking interval, touch sensing may be performed on the touch screen display (block 730). Also, at the beginning of the mid-frame blanking interval, the midporch counter may be set to the midporch width (block 735). For each line of dummy pixels that is generated during the mid-frame blanking interval, the midporch counter may be decremented (block 740).

Next, the display pipeline may determine if the midporch counter is equal to zero (conditional block 745). If the midporch counter is not equal to zero (conditional block 745, “no” leg), then method 700 may return to block 740. If the midporch counter is equal to zero (conditional block 745, “yes” leg), then the display pipeline may terminate the mid-frame blanking interval and go back to driving actual pixels to the display at the row where it had stopped (block 750). Next, the display pipeline may determine if there is another mid-frame blanking interval for the frame (conditional block 755). In some embodiments, there may be only a single mid-frame blanking interval per frame. In other embodiments, there may be multiple mid-frame blanking intervals per frame. In one embodiment, control logic of the display pipeline may determine if there is another mid-frame blanking interval for the frame by reading the table which stores the mid-frame blanking positions and widths for each mid-frame blanking interval.

If there are no other mid-frame blanking intervals for the current frame (conditional block 755, “no” leg), then the display pipeline may continue displaying actual pixels until the end of the frame is reached (block 760). After block 760, method 700 may return to block 705 to display the next frame. If there is another mid-frame blanking interval for the current frame (conditional block 755, “yes” leg), then the midporch position and width for the next mid-frame blanking interval may be loaded from the table (block 765). Then, after block 765, method 700 may return to block 715.

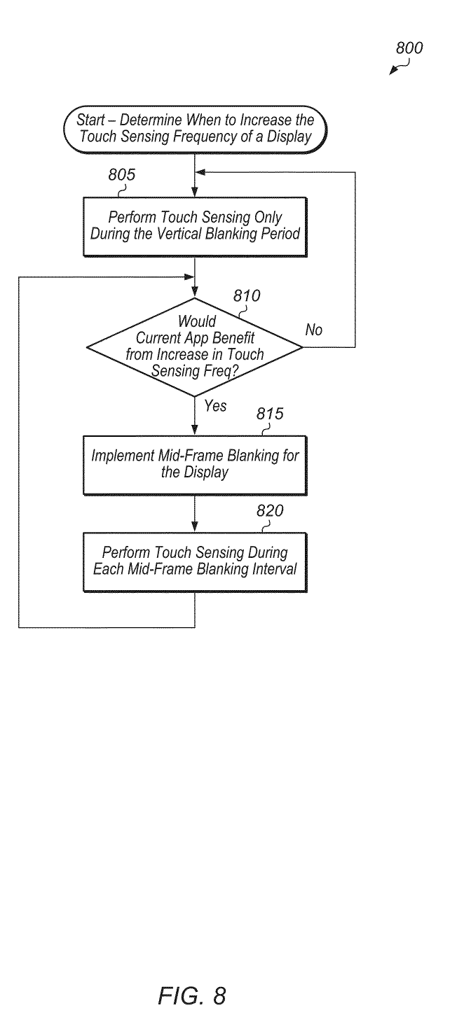

Referring next to FIG. 8, one embodiment of a method 800 for determining when to increase the touch sensing frequency of a touch sensitive display is shown. For purposes of discussion, the steps in this embodiment are shown in sequential order. It should be noted that in various embodiments of the method described below, one or more of the elements described may be performed concurrently, in a different order than shown, or may be omitted entirely. Other additional elements may also be performed as desired. Any of the various devices and display pipelines described herein may be configured to implement method 800.

A device may include a touch screen display and a display pipeline. In one embodiment, the device may run in a default mode where touch sensing is performed only at the start of each frame (during the vertical blanking period) (block 805). Next, the device may determine whether the application currently executing on the device would benefit from an increase in the touch sensing frequency (conditional block 810). For example, an application executing on the device may be waiting for the user to enter a signature on the touch screen display using a stylus or other similar device. For this application, an increased touch sensing frequency will allow for the user's signature to be captured with more accuracy. Other applications may also benefit from an increased touch sensing frequency if the user is drawing on the display, detecting force, detecting movement between touch positions, or performing tasks requiring rapid movements of a stylus or finger.

If the application would not benefit from an increase in the touch sensing frequency (conditional block 810, “no” leg), then method 800 may return to block 805. If the application would benefit from an increase in the touch sensing frequency (conditional block 810, “yes” leg), then display pipeline may enter a second mode of operation and implement mid-frame blanking for the display (block 815). The number of mid-frame blanking intervals that are introduced for each frame may vary depending on the type of application and how much the touch sensing frequency should be increased. During each mid-frame blanking interval, touch sensing may be performed to detect touch events on the display (block 820). After block 820, method 800 may return to block 810 to determine if the application still needs the higher rate of touch sensing.

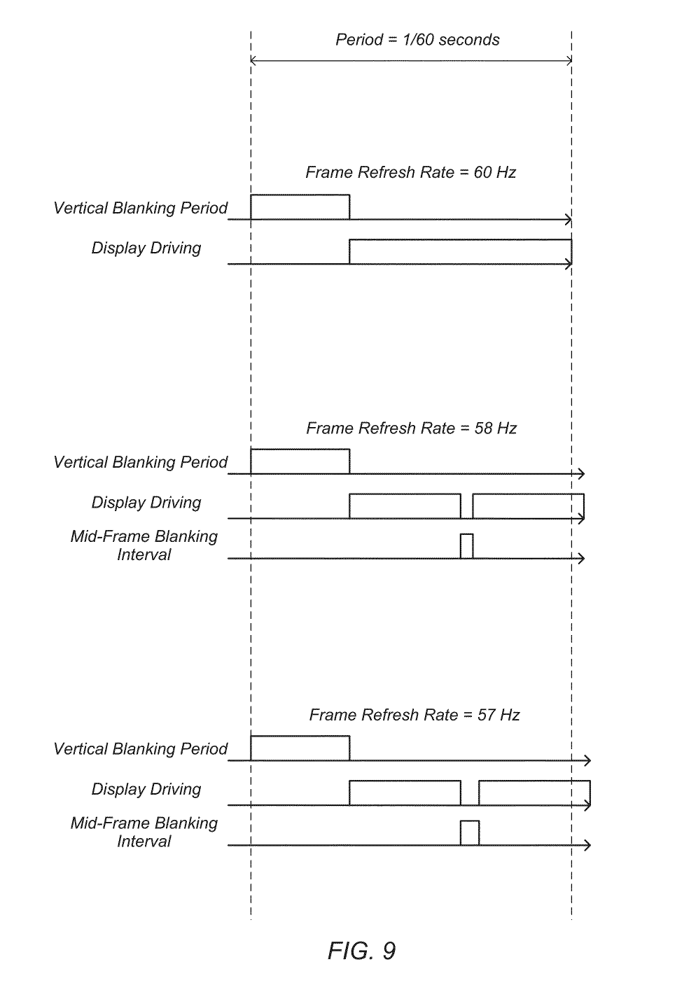

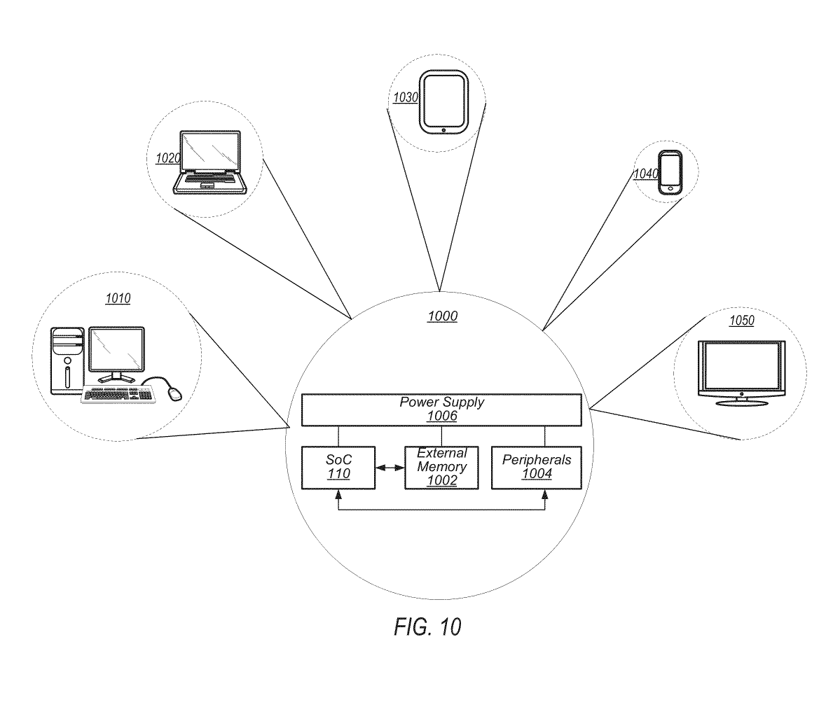

Turning now to FIG. 9, examples of adjusting the frame refresh rate using mid-frame blanking are shown. The dashed lines in FIG. 10 are meant to represent a period of time equal to 1/60 seconds. The frame at the top of FIG. 10 has a frame timing that exactly fits into this period, and this frame has a frame refresh rate of 60 Hz. This frame does not utilize mid-frame blanking but instead has a vertical blanking period followed by a single continuous period of display driving. The length of the vertical blanking period added to the length of the display driving period equals 1/60 of a second.

The second example of frame timing shown in the middle of FIG. 10 shows how the same duration of the vertical blanking period with the same total amount of display driving with an added mid-frame blanking interval may change the frame refresh rate from 60 Hz to 58 Hz. The display driving is now split up into two portions, with a mid-frame blanking interval inserted between the two portions of display driving. It may be assumed for the purposes of this discussion that the duration of the mid-frame blanking interval was chosen in order to adjust the frame refresh rate from 60 Hz to 58 Hz. The duration of the mid-frame blanking interval needed to effect this change in the frame refresh rate may be calculated as ( 1/58)−( 1/60) seconds.

Similarly, the third example of frame timing shown in the middle of FIG. 10 shows how the same duration of the vertical blanking period with the same total amount of display driving (as the 60 Hz frame rate example) plus an added mid-frame blanking interval may change the frame refresh rate from 60 Hz to 57 Hz. The duration of this mid-frame blanking interval may be calculated as ( 1/57)−( 1/60) seconds.

In other embodiments, the duration of the mid-frame blanking interval may be adjusted to create other frame refresh rates. Also, more than one mid-frame blanking interval may be utilized to change the frame refresh rate, with the total amount of time of the multiple mid-frame blanking intervals determining the change in the frame refresh rate. By performing mid-frame blanking, the display pipeline may choose the length of the mid-frame blanking interval to effect the desired change in the frame refresh rate. In this way, the display pipeline may be able to change the frame refresh rate of the display to match any rate at which the source pixel content is being rendered.

Referring next to FIG. 10, a block diagram of one embodiment of a system 1000 is shown. As shown, system 1000 may represent chip, circuitry, components, etc., of a desktop computer 1010, laptop computer 1020, tablet computer 1030, cell phone 1040, television 1050 (or set top box configured to be coupled to a television), or otherwise. Other devices are possible and are contemplated (e.g., wearable devices such as a watch, fitness band, pendant, glasses, ear mounted device, etc.). In the illustrated embodiment, the system 1000 includes at least one instance of SoC 110 (of FIG. 1) coupled to an external memory 1002.

SoC 110 is coupled to one or more peripherals 1004 and the external memory 1002. A power supply 1006 is also provided which supplies the supply voltages to SoC 110 as well as one or more supply voltages to the memory 1002 and/or the peripherals 1004. In various embodiments, power supply 1006 may represent a battery (e.g., a rechargeable battery in a smart phone, laptop or tablet computer). In some embodiments, more than one instance of SoC 110 may be included (and more than one external memory 1002 may be included as well).

The memory 1002 may be any type of memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with SoC 110 in a chip-on-chip configuration, a package-on-package configuration, or a multi-chip module configuration.

The peripherals 1004 may include any desired circuitry, depending on the type of system 1000. For example, in one embodiment, peripherals 1004 may include devices for various types of wireless communication, such as wifi, Bluetooth, cellular, global positioning system, etc. The peripherals 1004 may also include additional storage, including RAM storage, solid state storage, or disk storage. The peripherals 1004 may include user interface devices such as a display screen, including touch display screens or multitouch display screens, keyboard or other input devices, microphones, speakers, etc.

In various embodiments, program instructions of a software application may be used to implement the methods and/or mechanisms previously described. The program instructions may describe the behavior of hardware in a high-level programming language, such as C. Alternatively, a hardware design language (HDL) may be used, such as Verilog. The program instructions may be stored on a non-transitory computer readable storage medium. Numerous types of storage media are available. The storage medium may be accessible by a computer during use to provide the program instructions and accompanying data to the computer for program execution. In some embodiments, a synthesis tool reads the program instructions in order to produce a netlist comprising a list of gates from a synthesis library.

It should be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

1. An apparatus comprising:
a touch sensitive display; and
circuitry configured to drive frames to the display;
wherein the apparatus is configured to:
drive a portion of a given frame to the display, said portion representing less than all of the given frame;
insert a first mid-frame blanking interval subsequent to driving said portion and prior to driving the entire given frame;
enable touch sensing on the display during the first mid-frame blanking interval; and
resume driving the given frame.

2. The apparatus as recited in claim 1, wherein touch sensing is disabled while driving frames to the display, and wherein the display circuitry is configured to insert a plurality of mid-frame blanking intervals for each frame of a plurality of frames driven to the display.

3. The apparatus as recited in claim 1, wherein touch scans are enabled while driving frame data to the display, and wherein a stylus scan is enabled during the first mid-frame blanking interval.

4. The apparatus as recited in claim 1, wherein the apparatus is configured to insert said mid-frame blanking interval responsive to detecting a first mode of operation.

5. The apparatus as recited in claim 4, wherein the apparatus is configured to enable touch sensing only during periods between entire frames responsive to detecting a second mode of operation.

6. The apparatus as recited in claim 5, wherein for a given frame rate the apparatus is configured to:
generate a first vertical blanking interval with a first duration while operating in the second mode; and
generate a second vertical blanking interval and one or more mid-frame blanking intervals while operating in the first mode, wherein a cumulative duration of the second vertical blanking interval and the one or more mid-frame blanking intervals is equal to the first duration.

7. The apparatus as recited in claim 1, wherein the circuitry comprises one or more pixel processing pipelines, and wherein the circuitry is configured to:
stall the one or more pixel processing pipelines during the first mid-frame blanking interval;
generate dummy pixels during the first mid-frame blanking interval; and
discard or ignore the dummy pixels prior to the dummy pixels reaching the display.

8. A device comprising:
a touch sensitive display; and
logic configured to drive frames to the display;
wherein the device is configured to:
insert a first mid-frame blanking interval in an active period for a given frame; and
perform touch sensing on the display during the first mid-frame blanking interval.

9. The device as recited in claim 8, wherein the logic is configured to:
drive a first portion of the given frame to the display prior to the first mid-frame blanking interval; and
drive a second portion of the given frame to the display after the first mid-frame blanking interval.

10. The device as recited in claim 8, wherein the logic is configured to insert a plurality of mid-frame blanking intervals in the active period for each frame of a plurality of frames driven to the display.

11. The device as recited in claim 10, wherein each mid-frame blanking interval of the plurality of mid-frame blanking intervals is defined by a location and a width, wherein the location specifies where in the given frame the mid-frame blanking interval should be inserted, wherein the width specifies a duration of the mid-frame blanking interval, and wherein the location and width of each mid-frame blanking interval are programmable.

12. The device as recited in claim 10, wherein the logic is further configured to increase a number of mid-frame blanking intervals which are inserted in the active period in response to an indication that the device is running an application which would benefit from an increase in a frequency of touch sensing.

13. The device as recited in claim 8, wherein the logic is configured to drive frames to the display at a first frequency, wherein touch sensing is performed on the display at a second frequency, and wherein the second frequency is a multiple of the first frequency.

14. The device as recited in claim 8, wherein the logic comprises one or more pixel processing pipelines, wherein the logic is configured to:
stall the one or more pixel processing pipelines during the first mid-frame blanking interval; and
generate dummy pixels during the first mid-frame blanking interval.

15. A method comprising:
driving a portion of a given frame to a display, said portion representing less than all of the given frame;
inserting a first mid-frame blanking interval subsequent to driving said portion and prior to driving the entire given frame;
enabling touch sensing on the display during the first mid-frame blanking interval; and
resuming driving the given frame.

16. The method as recited in claim 15, further comprising disabling touch sensing on the display during the active period

17. The method as recited in claim 15, further comprising inserting a plurality of mid-frame blanking intervals for each frame of a plurality of frames driven to the display.

18. The method as recited in claim 17, further comprising inserting said mid-frame blanking interval responsive to detecting a first mode of operation.

19. The method as recited in claim 18, further comprising enabling touch sensing only during periods between entire frames responsive to detecting a second mode of operation.

20. The method as recited in claim 15, further comprising:
generating a first vertical blanking interval with a first duration while operating in the second mode; and
generating a second vertical blanking interval and one or more mid-frame blanking intervals while operating in the first mode, wherein a cumulative duration of the second vertical blanking interval and the one or more mid-frame blanking intervals is equal to the first duration.
